(19) United States
(12) Patent Application Publication
(10) Pub. No.: US 2007/0275470 A1
(43) Pub. Date: Nov. 29, 2007

(54) System and Method for Automatically Setting Operating Parameters for Micro-Dispensing Devices

(76) Inventors: Janice Lee Duff, Kingsford (AU); Edmond Joseph Breen, Berora (AU); Femia Hopwood, Winston Hills (AU); Martin Mueller, Berlin (DE)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/562,547

(22) PCT Filed: Jul. 12, 2004
(86) PCT No.: PCT/AU04/00929

§ 371 Date: Jun. 14, 2006

(30) Foreign Application Priority Data
Jul. 10, 2003 (AU) 2003903561

(51) Int. Cl. B67D 5/08; G01N 11/04; G01N 35/08

(52) U.S. Cl. 436/55

(57) ABSTRACT

A process for automating the setting of parameters for a micro jetting system for dispensing reagents and a jetting system and control system arranged to perform the process of the resent invention are disclosed. The parameters which are adjusted by the system, are voltage level and pulse duration. Typically, the process works by cycling through a plurality of combinations of the two parameters, imaging droplets produced by each of those parameters and analysing those images to detect whether a droplet is formed, and if so, whether that droplet is suitable. In a particularly preferred approach, a statistical approach is used to generate a range of appropriate parameter combinations and an associated likelihood of each of those parameter combinations being acceptable. In particular, the selection of parameter combinations starts with the statistically most popular occurrence of voltage and pulse duration and then alternates either side of the most popular occurrence with the next most popular occurrence which has not yet been used, until in acceptable droplet is produced.

### FIELD OF THE INVENTION

This invention relates to a system and method for automatically setting operating parameters for micro-dipensing devices.

### BACKGROUND OF THE INVENTION

Improvements in laboratory techniques and practices have led the discovery of an ever increasing number of new biomolecules. For example, now protein purification and detection methods have enabled the detection of many, possibly new, proteins. It is necessary to carry out molecular comparisons of any newly discovered biomolecules to determine to what extent they are similar to, or different from, known biomolecules. For example, to characterise a new protein, it is necessary to obtain amino acid sequence information relating to the protein. There a number of methods and techniques used in the analysis of biomolecules.

International patent application No WO 98/47006 entitled “Analysis of molecules” describes a method for analysing a sample in an array of samples including the steps of recording an image of the position of at least one sample relative to the other samples in an array, utilising the recorded image to apply a reagent or succession of reagents to the at least one sample in situ, and analysing the at least one sample for a reaction to or with the reagents. The specification also discloses an apparatus for carrying out such a process.

In carrying such an analysis, it is necessary to be able to accurately dispense very small quantities of reagent onto samples in the array. This is typically done with a piezoelectric operated glass capillary micro-dispensing device, also referred to as micro jets or jetting tubes in which droplets are dispensed from the devices by applying a voltage for a particular duration of time of the order of μs. Typically, the dispensed droplets are very small in volume being in the order of 100 pL.

Whilst there are a number of dispensing parameters which may be varied to adjust the formation of and characteristics of the dispensed droplets, the most significant parameters for droplet formation, are the voltage level and the pulse duration. These two parameters are adjusted so that an “acceptable” droplet is dispensed from the piezoelectric device. An acceptable droplet is one which exists (micro jets will not dispense droplets for some values of voltage and pulse duration) is stable (i.e. a series of substantially identical droplets are be dispensed be the combination of voltage and pulse duration) and which travels in an appropriate path. However, mechanical inaccuracies in micro jets and differences in sample viscosity require adjustment of the jetting parameters for successful operation.

Once the jetting tube has been loaded with a filtered sample and the back pressure has been correctly set, a user of the device will empirically determine a suitable combination of voltage and pulse duration by trial and error. The user's seek pattern is random and is almost always not reproducible. The user can waste considerable time in finding a suitable combination of voltage and pulse duration which produces an acceptable droplet. An unskilled user who is not familiar with the process of determining suitable parameters is unlikely to be able to find appropriate values in a reasonable time frame.

The present invention seeks to alleviate at least some or all of the disadvantages of the prior art and provide a system and method for automating the setting of parameters for micro jets.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the p8urpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

In a first broad aspect, the present invention provides a process for automating the setting of parameters for a micro jetting system for dispensing reagents and a jet system and control system arranged to perform the process of the present invention.

Typically, the parameters which are adjusted by the system are voltage level and pulse duration.

Typically, the process works by cycling through a plurality of combinations of the two parameters, imaging droplets produced by each of those parameters and analysing those images to detect whether a droplet is formed, and if so, whether that droplet is suitable.

In a particularly preferred approach, a statistical approach is used to generate a range of appropriate parameter combinations and an associated likelihood of each of those parameter combinations being acceptable.

More specifically, in one aspect the present invention provides a method of automating the setting of parameters most typically voltage level and pulse duration for a jetting tube for dispensing reagents comprising the steps of:

a) selecting a voltage range and a pulse duration range with each value in the range having an expected likelihood of suitability compared to other values in the range;

b) selecting a first combination of the parameters of voltage level and pulse duration;

c) supplying a pulse or series of pulses having the selected voltage and duration to the jetting tube;

d) taking an image of the droplet or droplets produced by the first combination of parameters and analysing that image to detect whether a droplet is formed, wherein

e) if a droplet is not detected selecting a further parameter combination; and

f) repeating steps (c) (d) and (e) until a droplet is detected; and

g) if a droplet is formed and detected, analysing an image of the droplet further to ascertain, whether other characteristics of the droplet are satisfactory; and;

h) if the other characteristics of the droplet are not satisfactory selecting a further parameter combination and repeating steps (c) to (g); and

i) if the other characteristics of the droplet are satisfactory saving those parameters for that jetting tube.

Most preferably the selection of parameter combinations starts with the most popular occurrence of voltage and pulse duration and then alternates either side of the most popular occurrence with the next most popular occurrence which has not yet been used.

The other characteristics of the droplet may include stability and flight angle.

### BRIEF DESCRIPTION OF THE DRAWINGS

A specific example of the present invention will now be described, by way of example only, and with reference to the accompanying drawings in which:

FIG. 1 is a schematic diagram of a system embodying the present invention;

FIG. 2 is a graph showing distribution of voltage against frequency from a compilation of 230 working sets of voltage and pulse duration parameters;

FIG. 3 shows a graph of pulse duration against frequency from the compilation of 230 working sets;

FIG. 4 is a graph showing a smoothed pulse duration curve with a range limitation from 5-80 μs;

FIG. 5 shows the graph of FIG. 4 with a dynamic base line out superposed thereon;

FIG. 6 is a schematic diagram/flow chart of the overall process of the present invention;

FIG. 7 is a flow chart outlining the steps of the present invention; and

FIG. 8 is a flow chart showing a variant of the steps in which some modules shown in FIG. 7 are combined.

### DETAILED DESCRIPTION OF A PREFERRED EMBODIMENT

Referring to the drawings, FIG. 1 shows a schematic diagram of a system generally indicated at 10 for carrying out the method of the present invention. A piezoelectric jetting tube 12 (such as is described in applicant's co-pending Australian provisional patent application No 2003901513, the contents of which are incorporated herein by reference) is driven by an electronic jet driver control 14 for generating a high voltage pulse, to cause a droplet 16 to be ejected from the micro jet. A camera 18 and a strobe LED 20 are disposed on opposite sides of the path that the droplet 16 takes. A personal computer (PC) 22 including a frame grabber card and imaging software analyses the image of the drop and issues signals to control the electronic jet driver 14.

In the method of the present invention, a high voltage pulse is generated by the electronic jet driver 14 of a particular voltage and duration. The pulse may or may not cause a droplet to be ejected from the micro jet. The region underneath the jet is exposed by the strobe LED, and an image of the droplet, (if present) is captured by the camera and transferred to the frame grabber card on the PC 22. The imaging software in the PC, discussed in more detail below, validates the image to see whether a droplet is or is not present and whether the droplet's flight angle, stability and droplet size, are satisfactory. If the droplet is satisfactory and meets all the requirements, the parameters (i.e. the voltage level and pulse duration) are saved, and the process is stopped. If the droplet formation is not satisfactory, the pulse duration and voltage level are varied, in a manner which is also described in more detail below, a further droplet is expelled from the micro jet, which is imaged and validated, the process continuing until a satisfactory droplet is produced.

Most micro jets are operated at a voltage of between 5-100 volts with a pulse duration from 5-80 μs to dispense droplets. The exact voltage, and pulse duration depend on the micro jet itself and the reagent being dispensed.

The process of the present invention automatically tests combinations of voltage and pulse duration until a satisfactory droplet is produced and then records the voltage and frequency producing a satisfactory droplet and subsequent droplets are dispensed using those parameters. If every single parameter combination were tested, in that limited range with every voltage level combined with every pulse duration incremented by one volt and one micro second respectively, 7125 parameter sets would have to be tested. Even using a very fast droplet search and evaluation algorithm, in the worst case scenario, if only the last combination tested produced an acceptable droplet, thirty minutes would typically be required to test every parameter combination and produce an acceptable result.

Thus, in the preferred aspect of the invention in order to reduce the running time, a droplet search algorithm was been developed based on statistical analysis of working sets of voltage and pulse duration.

In particular, FIG. 2 shows a compilation of 230 working sets of voltage against frequency based on previous experiments. The x axis shows the voltage value which was used to form a suitable droplet in a particular experiment and the y axis gives the frequency of times that that voltage was selected for a particular jetting operation in any of those 230 experiments.

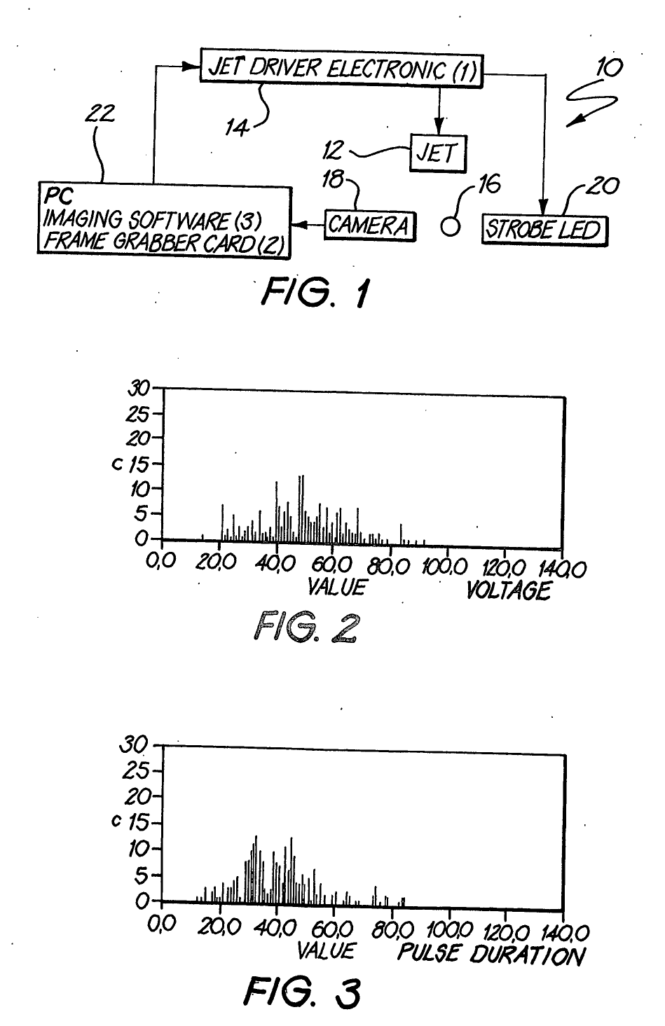

FIG. 3 is a similar graph showing the pulse duration statistics wherein x axis shows the value of pulse duration which was used to form a suitable droplet in a particular experiment and the y axis gives the frequency of times that that pulse duration was selected for a particular jetting operation in any of those 230 experiments.

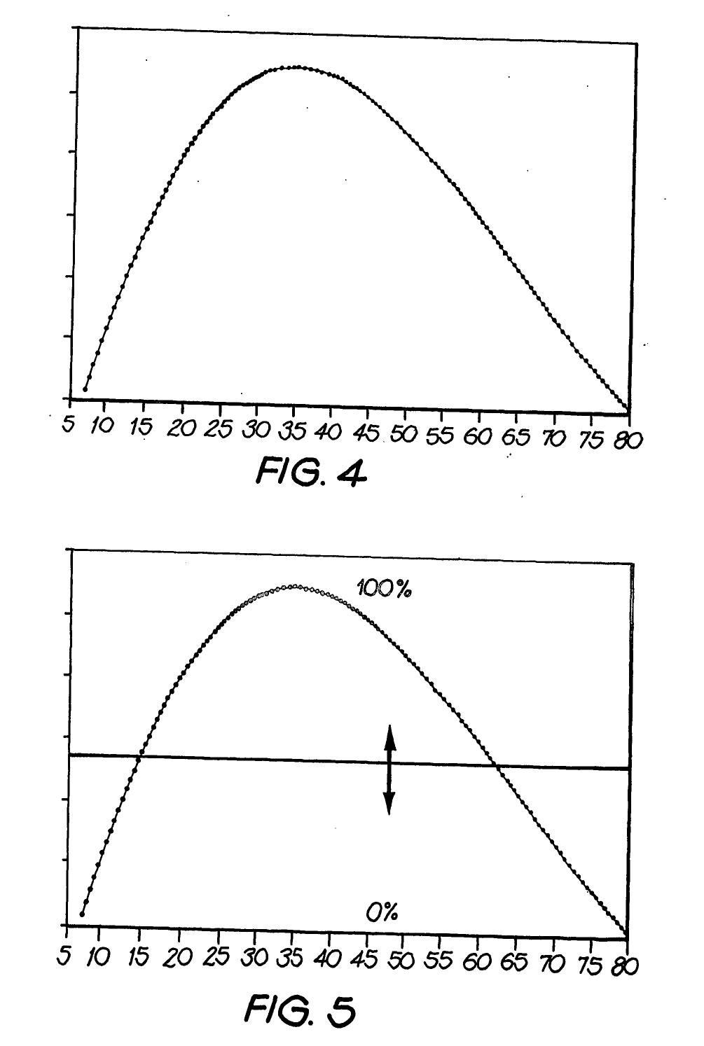

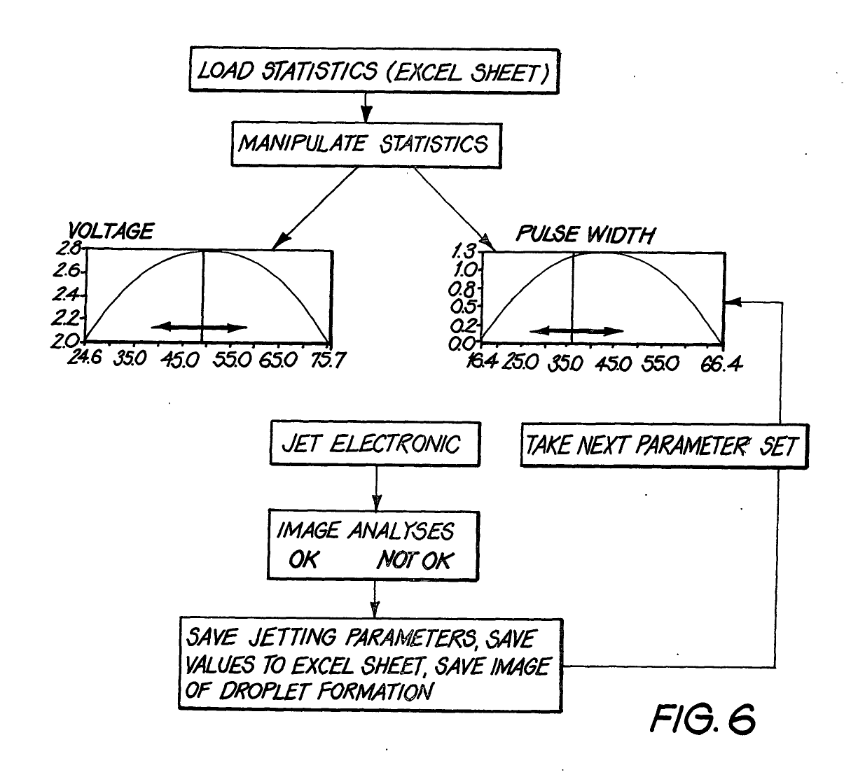

In the next stage, shown in FIG. 4, a smoothing algorithm is applied to the statistics for both the voltage and pulse duration fitting a polynomial curve to the statistics.

Using such a statistical approach, it is possible to reduce the number of parameter combinations that have to be tested since is unlikely that appropriate parameter combinations will be found at a low frequency of occurrence at the right or left hand end of the x axis and is more likely to find appropriate values close to the most frequently used parameter combinations i.e. near the peaks of the smoothed graphs.

FIG. 5 illustrates a movable/dynamic base line which reduces the number of parameter combinations to a reasonable level. The user can set the baseline where they chose. It is also possible to normalise the maximum occurrence to 100% and move the lower occurrence combinations appearing underneath the dynamic base line based on the new percentage scale. Experience has shown that a base line cut at 50% covers the most likely combinations and thus, significantly reduces the search time.

The reduced number of combination for voltage and pulse duration, are now used to find suitable parameter combinations. The routine starts by taking the first voltage level from the maximum of occurrence now 100% and combines it with each value of pulse duration which also starts at the maximum occurrence of 100%. If the maximum level of occurrence occurs at a voltage of, say, 50 volts, the first jetting setting is 50 volts in combination with the maximum occurrence of pulse duration which might for example, be 43 μs. A plurality of droplets are dispensed in sequence using those dispensing parameters to provide sufficient droplets for the imaging software to process, before the pulse duration is varied by 1 μs to 36 μs to form a plurality of droplets with dispensing parameters of 50V and 36 μs. Next 34 μs and 50V are the parameter combinations, 37 μs and 50V, 33 μs and 50V etc . . . until the maximum and minimum values of pulse duration are reached. The routine is then repeated with 51 volts and all combinations of pulse durations, 49 volts and all combinations of pulse durations 52 volts all combinations of pulse duration etc so that the testing of the parameter combinations starts at the most common occurrence and then tests parameter combinations continuously in a snake-like loop.

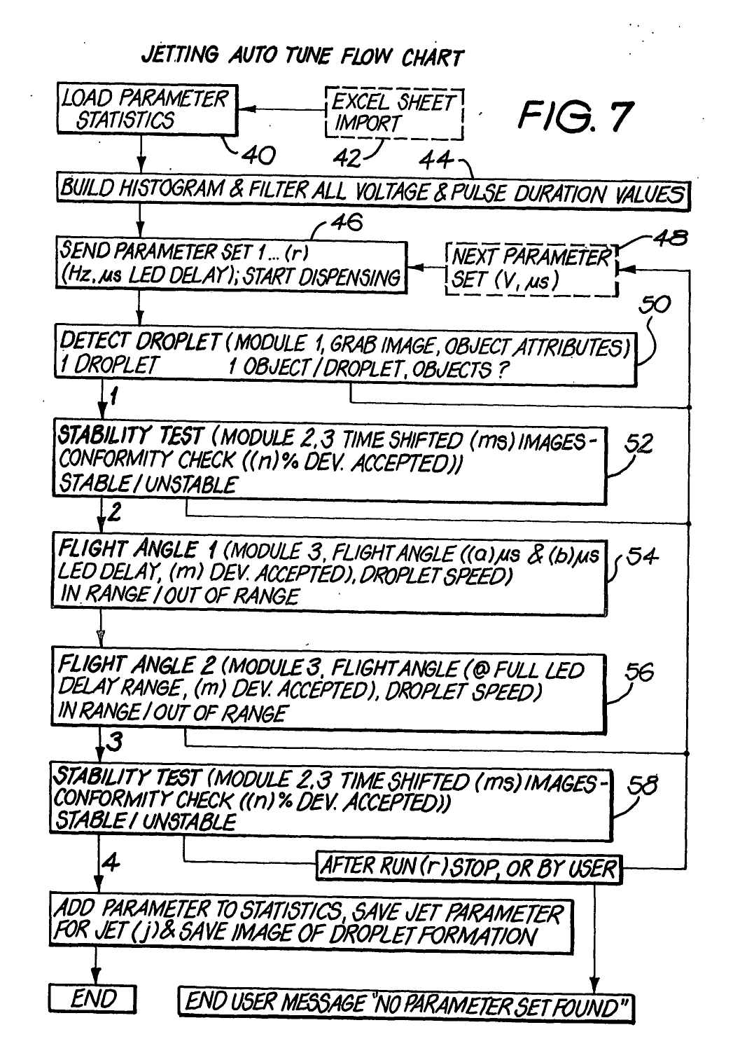

FIG. 7 is a flow chart setting out the steps in the process. The fist step 40 is the loading of the historical parameter statistics from an excel spreadsheet 42. Note that as the spreadsheet is updated after each operation of the jetting system hence the statistics are regularly updated. In the net step 44, a histogram is built and voltage and pulse duration values are filtered to remove unlikely values as described above with reference to FIGS. 2 to 5. Next the first parameter set is seat to the jet driver and in step 46 a series of pulses of the initial chosen duration and voltage are applied to the jetting device to cause droplets to be emitted. Images of the droplets are then analysed as follows.

The image analysis process, works as follows. First of all, the image of the droplet captured by the frame grabber is converted from grey level to a binary level.

The image evaluation algorithm is then separated into modules as follows. The first step or module 50 is ‘detect” droplet which analyses the droplet image and position. This module 50 checks whether there is no droplet, more one droplet, a droplet with a wrong diameter or a single droplet of the correct size. If this test is failed the next parameter set in the routine is chosen in step 48 according to the process described above.

However if the droplet passes the first test, the next test is the ‘stability test’ 52 which summarises three time shifted images to observe a stable droplet formation over a given time. The images are of different droplets all of which have however been ejected using the same parameter combination. If there is droplet position deviation of more than a given percentage, or a droplet shape deviation of more than a given percentage, the test is not passed. If the deviations are under the agreed percentage, typically 5%, the image is classified as stable. Failure of this test causes the next parameter set in the routine to be chosen in step 48.

If the stability test is passed, the next module is ‘flight angle 1’ 54 , and ‘flight angle 2’ 56 which determine the flight angle of a detected droplet. Two images are grabbed and evaluated at two fixed times after the droplet ejection. Based on these time shifted positions, the flight speed and angle are calculated. The flight angle test is passed if the flight angle is within a particular range.

There is a further module which extrapolates the data collected in the flight angle one module and uses it to calculate a flight path for the droplet and a final stability test 58 (similar to module 52) which checks that the two time shifted images are stable and do not deviate from one another by more than an allowed percentage.

In addition, all data relating to each combination of voltage and pulse duration and including voltage level, pulse duration, flight angle, speed of the droplet, diameter of the droplet, positional stability, shape stability and the image of the path of the droplet are saved to the Excel spreadsheet 42 for statistical purposes.

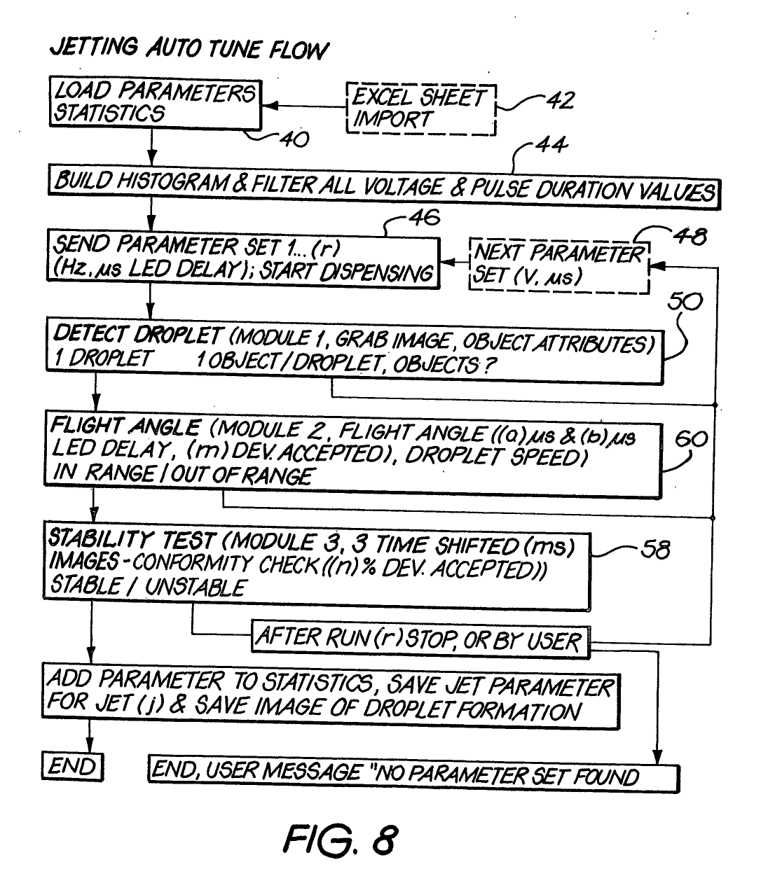

The modules may be modified as shown in the attached FIG. 8 in which the stability test 52 is omitted and ‘flight angle 1’ and ‘flight angle 2’ are combined in a single module 60.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of automating the setting of parameters, such as voltage level and pulse duration, for a jetting tube for dispensing liquids comprising the steps of:
a) selecting a voltage range and a pulse duration range with each value in the range having an expected likelihood of suitability compared to other values in the range;
b) selecting a first combination of the parameters of voltage level and pulse duration;
c) supplying a pulse, or series of pulses, having the selected voltage and duration to the jetting tube; and
d) detecting whether a droplet is formed, wherein e) if a droplet is not detected selecting a further parameter combination; and
f) repeating steps (c), (d) and (e) until a droplet is detected; and
g) if a droplet is formed and detected, analysing the droplet further to, ascertain whether secondary characteristics of the droplet are satisfactory; and wherein;
h) if the secondary characteristics of the droplet are not satisfactory, further including the step of selecting a further parameter combination and repeating steps (c) to (g); and
i) if the secondary characteristics of the droplet are satisfactory saving those parameters for that jetting tube.

2. A method as claimed in claim 1 wherein the expected likelihood of suitability of values in the ranges of pulse duration and voltage are determined from statistical analysis of results of previous jetting experiments.

3. A method as claimed in claim 2 wherein the selection of the first parameter combination commences with a statistically popular occurrence of voltage and pulse duration determined from the statistical analysis of results of previous jetting experiments.

4. A method as claimed in claim 3 wherein if the first parameter combination does not produce an acceptable droplet, second subsequent parameter combinations to be selected alternate either side of the first parameter combination with the next most popular occurrence which has not yet been used.

5. A method as claimed in claim 4 wherein one of the parameters is maintained constant while the second parameter is varied until all possible combinations of the second parameter with the one value of the first parameter are tested.

6. A method as claimed in claim 1 wherein the secondary characteristics of the droplet include stability and flight angle.

7. A method as claimed in claim 1 wherein the step of detecting whether a droplet is formed includes the step of taking an image of the droplet or droplets produced by the combination of parameters and analysing that image to identify whether a droplet is formed.

8. A method as claimed in claim 7 wherein the step of analysing the droplet further to ascertain, whether secondary characteristics of the droplet are satisfactory involves analysing an image or series of images of a droplet.

9. A method as claimed in claim 1 wherein a frequency distribution of voltage and pulse duration from previous jetting experiments is prepared prior to selecting the first combination of parameters from which statistically unlikely values at either end of the range of values are excluded from the range of parameters to be used.

10. A micro jetting system for dispensing liquids including a means for automating the setting of voltage level and pulse duration parameters of the micro jetting system including:
a jetting tube and control means for supplying a voltage pulse to the jetting tube having a known voltage for a known pulse duration;
means for capturing and analysing a image of a droplet jetted from the tube;
means for building or storing a frequency distribution of voltage and pulse duration from previous jetting experiments; and control means arranged to
a) based on the frequency distribution, select a voltage range and a pulse duration range with each value in the range having an expected likelihood of suitability compared to other values in the range;
b) select a first combination of the parameters of voltage level and pulse duration;
c) supply a pulse or series of pulses having the selected voltage and duration to the jetting tube; and
d) detect whether a droplet is formed, wherein
e) if a droplet is not detected select a further parameter combination; and
f) repeat steps (c) (d) and (e) until a droplet is detected; and
g) if a droplet is formed and detected, analyse the droplet further to ascertain, whether secondary characteristics of the droplet are satisfactory; and wherein;
h) if the secondary characteristics of the droplet are not satisfactory select a further parameter combination and repeating steps (c) to (g); and
i) if the secondary characteristics of the droplet are satisfactory save those parameters for that jetting tube.

11. A micro jetting system as claimed in claim 10 wherein the first combination of parameters selected is the statistically most common voltage and pulse duration value based on the frequency distribution.

12. A micro jetting system as claimed in claim 10 wherein further parameter combinations are dispensed in sequence where necessary until a satisfactory combination is found, with combinations to be selected alternating either side of the statistically most common voltage and pulse duration with the next most popular occurrence which has not yet been tried.

13. A method of automating the setting of parameters, such as voltage level and pulse duration, for a jetting tube for dispensing liquids comprising the steps of:
a) selecting a voltage range and a pulse duration range with each value in the range having an expected likelihood of suitability compared to other values in the range determined from statistical analysis of results of previous jetting experiments;
b) selecting a first combination of the parameters of voltage level and pulse duration being a statistically popular occurrence of voltage and pulse duration determined from the statistical analysis of results of previous jetting experiments;
c) supplying a pulse, or series of pulses, having the selected voltage and duration to the jetting tube; and
d) detecting whether a droplet is formed, wherein
e) if a droplet is not detected selecting a further parameter combination; and
f) repeating steps (c), (d) and (e) until a droplet is detected; and
g) if a droplet is formed and detected, analysing the droplet further to ascertain whether secondary characteristics of the droplet are satisfactory; and wherein;
h) if the secondary characteristics of the droplet are not satisfactory, further including the step of selecting a further parameter combination and repeating steps (c) to (g); and
i) if the secondary characteristics of the droplet are satisfactory saving those parameters for that jetting tube.

14. A method as claimed in claim 13 wherein the first combination of parameters selected is the statistically most common voltage and pulse duration value based on the frequency distribution.

15. A method as claimed in claim 13 wherein further parameter combinations are dispensed in sequence where necessary until a satisfactory combination is found, with combinations to be selected alternating either side of the statistically most common voltage and pulse duration with the next most popular occurrence which has not yet been tried.
